(19) United States
(12) Patent Application Publication
(10) Pub. No.: US 2023/0326658 A1
(43) Pub. Date: Oct. 12, 2023

(54) MAGNETIC CIRCUIT, MAGNETIC COMPONENT AND METHOD FOR MANUFACTURING A MAGNETIC COMPONENT

(71) Applicant: Schaffner EMV AG, Luterbach (CH)

(72) Inventor: Stefanos Panagiotis GRANITSAS, Zuchwil (CH)

(21) Appl. No.: 18/123,735

(22) Filed: Mar. 20, 2023

(30) Foreign Application Priority Data
Mar. 28, 2022 (EP) 22164806.6

(51) Int. Cl. H01F 27/26; H01F 27/29; H01F 17/04; H01F 3/10

(52) U.S. Cl. CPC H01F 27/266; H01F 3/10; H01F 17/045; H01F 27/292

(57) ABSTRACT

The present invention rates to a closed magnetic circuit for guiding a magnetic flux having a magnetic core with a first core member and a second core member, wherein the first core member being configured with an opening and a portion of the second core member is accommodated in the opening such that a gap for increasing the reluctance of the closed magnetic circuit is provided and encircles the portion of the core member. The present invention further relates to a magnetic component having the closed magnetic circuit and a carrier for holding the closed magnetic circuit and securing the gap. The present invention also relates to a method for manufacturing a magnetic component.

### REFERENCE DATA

The present application claims priority of European patent application EP22164806 of Mar. 28, 2022, the content whereof are entirely incorporated.

### TECHNICAL DOMAIN

The present invention concerns a magnetic circuit with improved magnetic stability over a high temperature range, a magnetic component with enhanced mechanical properties and a method for manufacturing the magnetic component.

### RELATED ART

Magnetic components are key elements of power electronics and are found in a wide range of applications in all industrial sectors. Inductors are used, among others, in filter, voltage converters, and in power factor compensation.

Besides their electrical characteristics, magnetic components must also fulfil specifications for dimensions, heat dissipation, heat resistance, immunity to vibrations, and many other parameters. In automotive applications, where magnetic components are increasingly common, these specifications are especially stringent. As a result, magnetic components are complex products that are difficult to design and customize to all the possible applications.

A state-of the art magnetic component is the result of a trade-off between the desired nominal inductance value, the size, weight, and footprint dictated by the desired application, the choice of material, layout, and cooling.

Applications to the automotive sector, as well as in other demanding areas, require superior manufacturability, reliability, resistance to mechanical shocks and vibrations in an extended temperature range, together with a precise control of the tolerances and low thermal drifts.

FIG. 1 shows an example of a magnetic component 2 well known from the prior art. The magnetic circuit 1 consists of a first core member 10, a second core member 20, two spacers 3 and two coils (not illustrated) carried by the second core member 20. The coils can be connected to a device external to the magnetic component 2, for example, a power converter for supplying electrical power to a consumer in a vehicle.

Depending on the interconnection of the coils, can the magnetic component provide a common-mode choke, differential-mode choke, line inductor or a transformer.

The first core member 10 is provided in the form of a solid elongated plate. The second core member 20 is provided in a U-shape with a solid elongated plate and two limbs in the shape of round cylinders attached to and extending from the solid elongated plate.

The core members 10, 20 are made of a soft magnetic material, whereas the second core member 20 is an assembly formed by the solid elongated plate and the limbs attached to the plate by an adhesive bond.

The spacers 3 are provided in the form of two round flat plates. The spacers 3 are made of an electrically non-conductive, non-magnetic material such as a glass-reinforced epoxy laminate or ceramic material. The two materials as mentioned are just a limited selection of well-known materials. Other materials might be used instead.

Glass-reinforced epoxy laminate materials are inexpensive and can be machined with standard tools and equipment available in most industries nowadays. Ceramic materials, to the contrary, are expensive materials and they need to be machined carefully using special tools and equipment.

The two materials are different in their coefficient of expansion and contraction. Epoxy laminate materials expand/contract more when facing temperature variation than ceramic materials.

The spacers 3 are placed between the top surface of the first core member 10 and the distal ends of the limbs of the second core member 20. The spacers 3 are fixated with glue to the first and second core member 10, 20 to form a magnetic circuit assembly 1.

The spacers 3 are providing two gaps between the first and second core member 10, 20 to increase the reluctance of the magnetic circuit 1 and energy can be stored in said gap. The gap is sometimes referred to as “airgap”, even when it is not filled with air but with a non-conductive, non-magnetic material having magnetic properties comparable with air.

The magnetic circuit assembly 1 is placed inside housing 4. The housing 4 can be filled with a potting compound to hold the magnetic circuit 1 and provide a thermally conductive path for cooling between housing 4 and the magnetic circuit assembly 1.

Using spacers 3 made of the example materials as outlined before has many disadvantages. The spacers 3 need to be glued or fixated differently to the first and second core member 10, 20.

This is disadvantageous as the glue needs to harden, before the housing 4 can be filled with potting compound. It increases the time for manufacturing the magnetic component 2 drastically, which leads to additional costs, particularly when the magnetic component 2 is destined for manufacturing in mass production.

On the other hand needs the gap mechanically constant over a high temperature range, so that the reluctance of the magnetic circuit 1 does not vary. Any mechanical variation of the gap leads to a decrease or increase of the reluctance of the magnetic circuit 1.

Thus, glass-reinforced epoxy laminate materials are often unsuitable for this purpose, whereas ceramic materials are too expensive when the magnetic component shall be manufactured in high volumes, even when they provide improved stability over a high temperature range.

Other solutions known from prior art doesn’t provide a satisfactory solution for the technical problems as set-out before either.

US6919788 discloses electrical inductors or transformers with a low profile and suitable to carry high amount of currents. The inductors/transformers includes a ferromagnetic core structure with multiple gaps to reduce stray electromagnetic fields. The ferromagnetic core structure is held in place by using adhesives, whereas the gaps are secured by potting material.

US20150170820 discloses magnetic component assemblies for circuit boards including single, shaped magnetic core pieces formed with a physical gap and conductive windings assembled to the cores via the gaps. The physical gaps in the core are filled with an expandable magnetic material to eliminate minute non-magnetic gaps and enhance magnetic performance. Thus, this disclosure suggests avoiding non-magnetic gaps at all. The magnetic component assemblies may define power inductors.

US20110133874 discloses a method for making a magnetic component. The method comprises providing a core with one or more ridges protruding from one or more surfaces of the core; depositing one or more electrically conductive materials on the core; and removing at least a portion of the one or more ridges to form one or more continuous conductors wound around the core. Each of the one or more continuous conductors defines at least one insulating gap. Further, a magnetic component and methods for making the magnetic component are presented.

### SHORT DISCLOSURE OF THE INVENTION

The present invention aims to provide a magnetic circuit that overcomes the shortcomings and limitations of state of the art. The present invention provides a magnetic circuit with stable electrical properties over a high temperature range, in particular with respect to the stability of the reluctance. The stability of reluctance of the magnetic circuit is crucial and often a concern discussed in state of the art.

In addition and closely linked to the first aim, provides the invention a solution that overcomes the shortcomings and limitations of state of the art by the provision of a magnetic component that has stable electrical properties over a high temperature range by waiving the need of loose spacers for providing an axial gap.

The present invention aims to provide a method for manufacturing a magnetic component that is suitable for manufacturing the magnetic circuit and the magnetic components in high volumes by drastically reducing the steps needed for manufacturing. The magnetic circuit and the magnetic component can be manufactured without the need of adhesives to secure the gap between the first and second core member. The bill of material for producing the magnetic component is reduced at the same time.

According to the invention, these aims are attained by the object of the attached claims, and especially by a magnetic circuit for guiding a magnetic flux generated by a coil carrying an electric current.

The magnetic circuit comprises a magnetic core with a first core member and a second core member, wherein the first core member is configured with an opening having a sidewall with a first surface, wherein the opening accommodates only a portion of the second core member, the portion having an outer wall with a second surface, wherein the sidewall and the outer wall are mutually facing each other and the portion of the second core member is configured such that the first and second surface are separated by a gap increasing the reluctance of the magnetic circuit.

The opening might accommodate only a portion of the second core member, meaning that the second core member may not be entirely accommodated in the opening comprised in the first core member. Thus some portions of the second core member might protrude and/or stand out from the opening.

The gap can enclose and/or encircles the portion of the second core member accommodated in the opening and may be configured to extend radially or with radial symmetry relative to the portion of the second core member accommodated in the opening.

The opening of the first core member can be designed as a through-hole and the portion of the second core member accommodated in the trough-hole may extend via the full extension of the through-hole for providing the gap along with the full extension. Alternatively, the opening might be configured as a blind hole.

The outline contour of the portion of the second core member accommodated in the opening being a blind hole or a through-hole can be equal to an inner contour of the opening or through-hole, wherein the outline or inner contour may be circular, elliptic, rectangular, polygonal or triangular.

An electrically non-conductive, non-magnetic element may be arranged in the gap and can be in contact with the first and second surface to define and secure a distance between the first surface and the second surface for mechanically securing the second core element with respect to the first core element.

The said element can be made of an elastic material, such as industrial silicone or may be provided by a plastic material suitable for this kind of application. The material might keep its mechanical properties in a temperature range between -40° C. and +160° C. The shape of the element can correspond to the outline contour and/or the inner contour of the of the opening or through-hole.

The magnetic circuit can comprise a coil for generating an alternating magnetic field. The coil may be wound around the second core member and may comprise an electrical insulation for insulating the coil from the second and first core members.

Alternatively or in addition can the electrically non-conductive, non-magnetic element be configured and used to insulate the coil from the first and/or second core member.

The first and/or the second core member can comprise and may be made of a soft magnetic material, such as soft ferrite, being one or a combination of manganese-zinc or/and nickel-zinc. Alternatively, or in addition, can the core members comprise other soft magnetic materials, such as iron powder.

The first and second core members may comprise an elongated member in the shape of a plate.

The second core member can include a plurality of elongated limbs attached to and extending from one surface of the elongated member of the second core member. The second core member can be configured with a clearance hole extending through at least one elongated limb and the elongated member of the second core member.

The magnetic circuit can be configured with a first core member comprising a plurality of openings in the form of blind holes and/or a plurality of through-holes. Each of the openings and/or through holes may accommodate a portion of an elongated limb of the second core member.

The first and/or second core member can be formed integrally, whereas the shape is obtainable in one manufacturing step using a compression mould.

These aims are further attained by the object of a magnetic component, such as inductor or transformer, comprises a magnetic circuit as disclosed before and a carrier for accommodation the magnetic circuit with a base plate having an upper surface and a lower surface, wherein the lower surface being substantially flat and wherein the upper surface being configured with a plurality of protrusions extending from the upper surface and being configured for holding the magnetic circuit, wherein a first protrusion is elongated with reference to a second protrusion.

The magnetic component can be mounted in a vehicle, such as an automotive, and being part of the vehicle’s electrical power supply. The temperature range in which the magnetic component can be operated reaches from -40° C. to +160° C., or even higher.

The first and second protrusion can be provided by an electrically non-conductive material, non-magnetic material, preferably one or a mixture of a plastic, ceramic, rubber, silicone or composite material.

The carrier can be made of the same material as the first and second protrusion.

The first protrusion and/or the second protrusion can be configured to extend via the through-hole comprised in the first core member of the magnetic circuit as disclosed before, wherein the electrically non-conductive element of the magnetic circuit arranged in the gap may be provided by the first or second protrusion, extending via the through-hole.

The first and/or the second protrusion can be configured to secure the first core member by providing a mechanical connection between a surface of the first core member and the protrusion. The mechanical connection may be established by using a press fit, tight fit and/or snug fit.

The first protrusion can be configured to secure the second core member, wherein the first protrusion may enclose the portion of the second core member and/or may extend through the clearance hole comprised in at least one limb of the second core member.

The first or the second protrusion may further extend into or extend via the gap provided between the first core member accommodating a portion of the second core member in the through-hole of the first core member and may hold the gap mechanically constant.

The first protrusion can be elongated and may has a distal end. The first protrusion can be configured to enter the clearance hole comprised in the second core member at one end and may exit the clearance hole at a second end, such that the distal end can protrude from the second end of the clearance hole to form an excess length.

The magnetic component can be configured with a carrier having a plurality of protrusions similarly configurated as the first and/or the second protrusion disclosed before, wherein each can be provided for securing a first and/or a second core member.

A third protrusion (or a plurality of third protrutions) may extend from the second surface and can be configurated to circumferentially surround the base plate for providing a raised border and thereby enclosing an inner volume.

The magnetic component may be configured with a plurality of lashes extending from the base plate and suitable for fixing the carrier on a surface, preferably a surface of a cooling plate external to the magnetic component.

The shape of the carrier may be formed integrally in one manufacturing step by means of a compression mould.

Another aim is attained by a method for manufacturing a magnetic as disclosed hereinbefore.

The method comprises the steps of providing a carrier, a first and a second core member and securing a position of a portion of the second core member accommodated in an opening of the first core member by means of a protrusion provided on a surface of the carrier.

a method for manufacturing a magnetic as disclosed hereinbefore, the method comprises the steps of providing a carrier, a first and a second core member and securing a position of a portion of the second core member accommodated in an opening of the first core member by means of a protrusion provided on a surface of the carrier.

The method may comprise the step of pushing a second protrusion through a through-hole provided in the first core member and thereby providing a first firm mechanical connection between the second protrusion and the first core member by applying mechanical and/or thermal energy to the second protrusion.

Applying mechanical and/or thermal energy to the second protrusion might lead to forming the second protrusion into a different shape being suitable to hold the first and/or second core member.

The method may include the step of pushing a first protrusion being configured in an elongated shape and having a distal end, through a clearance hole provided in the second core member and thereby providing a second firm mechanical connection between the distal end and the second core member using a machine or means for screwing, riveting, pressing and/or melting.

The method can also comprise the step of filling an inner volume of the carrier with a potting compound and letting the potting compound cure. Alternatively, can the use of potting compounds be omitted. In this situation, might the base plate not be configured with a third protrusion circumferentially surrounding the carrier. This can be advantageous when the magnetic component is cooled by convection.

### SHORT DESCRIPTION OF THE DRAWINGS

Exemplar embodiments of the invention are disclosed in the description and illustrated by the drawings in which:

FIG. 1 illustrates an example of a magnetic component known from prior art.

FIGS. 2A and 2B illustrate an example of a first core member in the shape of a plate with an opening and a through-hole in a sectional view.

FIG. 2C illustrates in a sectional view an example of a second core member with a plate and limbs extending from the plate.

FIG. 3 illustrates a magnetic circuit with a first and second core member and an electrically non-conductive element securing a gap mechanically in a sectional view.

FIG. 4 illustrates in a sectional view an example of a magnetic component according to a first embodiment.

FIG. 5 illustrates an example of a magnetic component according to a second embodiment.

FIG. 6 illustrates an example of a carrier for the magnetic component of the second embodiment in a sectional view.

FIG. 7 illustrates in a sectional view an example of a magnetic circuit of the second embodiment.

FIG. 8 illustrates the gap provided between the first and second core member of the magnetic circuit of the second embodiment in a top view.

FIG. 9 illustrates an example of an assembly of the magnetic component in a sectional view according to the second embodiment.

FIG. 10 illustrates in a sectional view an example of an assembly of the magnetic component according to the second embodiment, whereas the core members are mechanically secured.

It needs to be noted that all drawings herein presented are not in scale and might differ in size and/or scale when embodied.

### EXAMPLES OF EMBODIMENTS OF THE PRESENT INVENTION

All examples presented herein are axially symmetric, indicated by a dotted line in the figures.

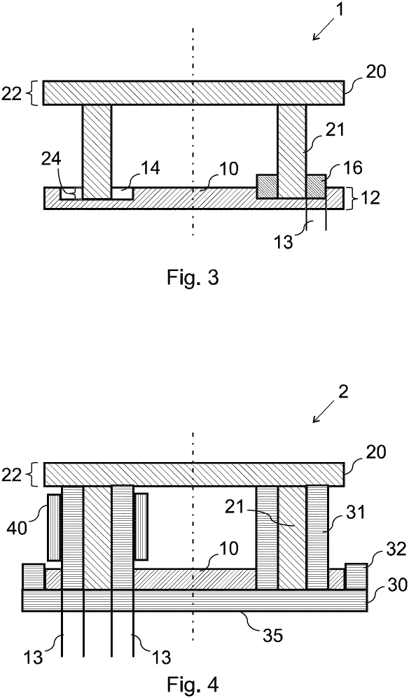

FIGS. 2A to 2C illustrate multiple examples of the core members 10, 20. All core members 10, 20 are made of a soft magnetic material, such as electronic iron, Si-steel, Manganese-zinc or Nickel-zinc ferrite and/or a combination thereof. Amorphous and nanocrystalline alloys might be used alternatively.

In a sectional view illustrates FIG. 2A a first core member 10 in the shape of an elongated plate 12. The elongated first core member 10 comprises two openings 14, each configured as a blind hole, extending into the elongated plated 12 by approximately ⅔ in thickness. The blind holes 14 are provided in a circular shape, which might be drilled into the material using a milling head. Each blind hole 14 comprised an inner sidewall 15 with a surface and a bottom wall with another surface.

FIG. 2B shows the first core member 10 of FIG. 2A with the difference that the openings 14 are provided by through-holes 11, each comprising an inner sidewall 15 with a surface. The bottom wall is omitted accordingly. The shape of the first core member 10 can be provided in one manufacturing step by pressing the magnetic material using a compression mould.

All following examples use the first core member 10 as disclosed before and illustrated in FIGS. 2A or 2B. The shape of an elongated plate 12 is synonym for other suitable shapes. Thus, any other shape, with one, two or more openings, might be used instead.

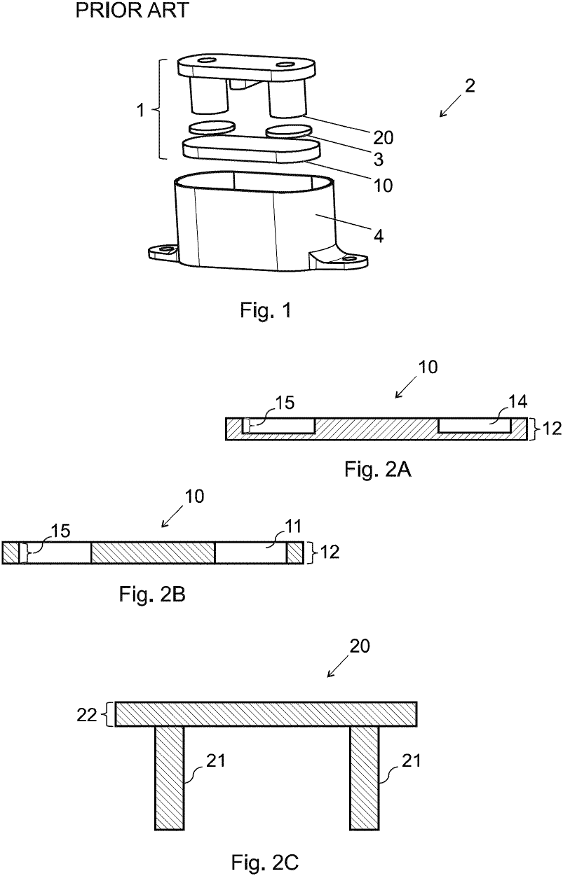

The second core member 20, of FIG. 1 is also illustrated in FIG. 2C in a sectional view with fewer details.

The second core member 20 comprises in this example an elongated plate 22 and two elongated limbs 21 extending from the elongated plate 22 of the second core member 20. The shape of the elongated limbs 21 is circular.

In contrast to the example shown in FIG. 1, the second core member 20 in FIG. 2C is integrally formed. The shape of the second core member 20 can be provided in one manufacturing step by pressing the magnetic material using a compression mould.

The following examples use the second core member 20 as disclosed before and illustrated in FIG. 2C, if not stated differently. The shape of an elongated plate 22 along with the limbs 21 is synonym for other suitable shapes. The second core member 20 might be configured with a different number of limbs 21 or a different number of other protrutions extending from or being part of the second core member 20.

FIG. 3 illustrates a magnetic circuit 1 formed by the magnetic core members 10, 20 shown in FIGS. 2A and 2C. The magnetic circuit 1 comprises, in this example, a first core member 10 in the shape of an elongated plate 12, with two openings 14 being configured as blind holes. The second core member 20 comprises a further elongated plate 22 and two elongated limbs 21 extending from the elongated plate 22 of the second core member 20.

The blind holes 14 and the elongated limbs 21 are configured in a circular shape. The diameter of the blind holes 14 is greater than the diameter of the elongated limbs 21.

Each blind hole 14 accommodates a portion 24 of one elongated limb 21. The end faces of the elongated limbs 21 are in contact with the bottom wall of the blind holes 14. Each portion 24 of an elongated limb 21 is placed in the corresponding blind hole 14, such that the sidewall 15 of the blind hole 14 surrounds the portion 24 accommodated in the blind hole 14 radial symmetrical. The position of limbs 21 is secured by the spacer 16 introduced into the gap 13 between the sidewall 15 of the blind hole 14 and the portion 24.

The spacer 16 for securing the position is made of a non-conductive, non-magnetic material. In this example, a rubber or industrial silicone material provides a tight connection between the inner wall 15 of the blind hole 14 and portion 24 for securing the position. For manufacturing are the spacers 16 first pushed into the blind holes 14 and each limb 21 is inserted into a corresponding opening comprised in the spacer 16.

Arranging the gap 13 radially between the inner wall 15 of a blind hole 14 and a portion 24 of one elongated limb 21 provides the advantage that magnetic properties, such as the reluctance of the magnetic circuit 1, are more stable over an extended temperature range compared to the magnetic circuit 1 disclosed in FIG. 1. Due to its geometry, the mechanical variation of the gap over temperature is more limited than the example discussed in FIG. 1.

FIG. 4 shows an example of a magnetic component 2 in a sectional view, comprising the core members 10, 20 as illustrated in FIGS. 2B and 2C. The core members 10, 20 provide a magnetic circuit. The magnetic component 2 comprises a coil 40 for generating a magnetic field resulting in a flux guided by the magnetic circuit and formed by the first and second core members 10, 20. The magnetic circuit and the coil 40 are supported and mechanically fixated by the carrier 30.

The first core member 10 is provided in the form of an elongated plate, with two through-holes as illustrated in FIG. 2B. The second core member 20 is similarly configured as in the examples shown in FIG. 2C or FIG. 3, with an elongated plate 22 and two limbs 21 extending from the elongated plate 20.

The trough-holes and the elongated limbs 21 are configured in a circular shape. The diameter of the trough-holes is greater than the diameter of the elongated limbs 21.

The carrier 30 is made in this example of plastic material, preferably in the form of a thermosetting polymer with high thermal conductivity. The carrier 30 comprises a base plate (not referenced) with a lower surface 35. The lower surface 35 can be brought into contact with a cooling plate of an external cooling device for cooling the magnetic component 2.

Multiple protrusions 31, 32 extending from the upper surface of the base plate of the carrier 30. Each of the most elongated protrusions 31 extend via a through-hole provided in the first core member 10. The most elongated protrusions 31 are configured to contact the inner wall of the through-holes of the first core member 10 and provide a snug fit.

Each of the most elongated protrusion 31 is provided with an inner volume. The elongated limbs 21 of the second core member 20 are accommodated in said inner volume and are mechanically secured by most elongated protrusions 31.

It can be noticed that the most elongated protrusions 32 provide multiple functions to the magnetic component 2. They mechanically secure and hold the first and second core members 10, 20 in place. The most elongated protrusions 32 also secure the gap 13 between the sidewall of the through-hole and the portion of the elongated limbs extending via the through-holes provided in the first core member 10. The portion of the elongated limbs extends via the through-hole and the full extension of the trough-hole.

The most elongated protrusion 32 on the left also provides an insulation barrier between the coil 40 and the limb 21 of the second core member 20.

Second protrutions 32 on the outer left and right extendfrom the base plate of the carrier 30 for securing the first core member 10.

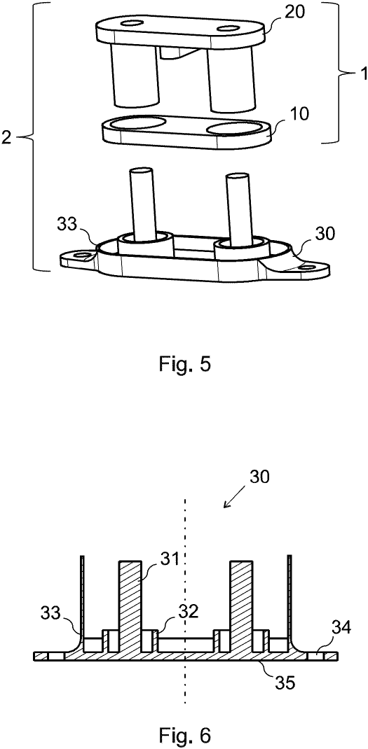

FIG. 5 illustrates a further example of a magnetic component 2, comprising a first and a second core member 10, 20 for providing a magnetic circuit 1. The carrier 30 provides the same functionality as the carrier disclosed in FIG. 4, namely securing the core members 10, 20. The carrier comprises a third protrusion 33, surrounding the the base plate of the carrier 30.

FIG. 6 illustrates in a more detailed sectional view the carrier 30 shown in FIG. 5.

The carrier 30 is configured with a base plate having a lower surface 35. Multiple protrusions extend from the upper surface of the base plate. Two most elongated protrusions in the form of cylinders are extending from the upper surface. Second protrusion 32 partly enclose the most elongated protrusions 31 and a third protrusion 33 surrounds the base plate to provide a side wall of a housing enclosing an inner volume. The carrier 30 is made of a plastic material with high thermal conductivity. Laces 34 with holes on the left and right are provided to fixate the carrier 30 on an external surface, such as a cooling plate.

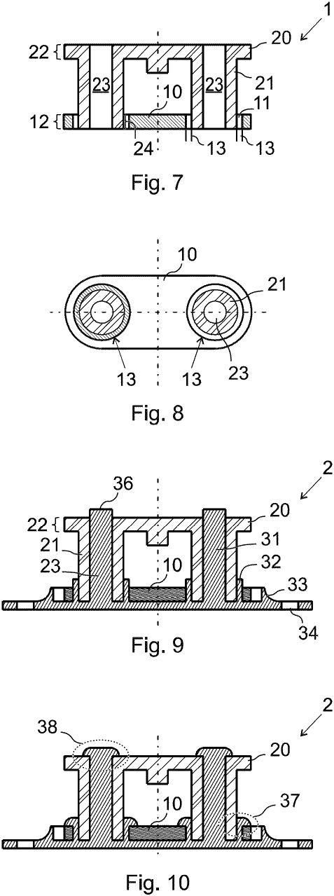

FIG. 7 illustrates in a more detailed sectional view the magnetic circuit 1 shown in FIG. 5. The magnetic circuit 1 comprises a first core member 1 in the form of an elongated plate 12 having two through-holes 11. The second core member 20 has an elongated plate 22 and two elingated limbs 21 extending from the elongated plate 22. The limbs 21 are hollow, as a clearance hole extends through the limbs 21 and the elongated plate 22.

Each through-hole 11 accommodates a portion 24 of the elongated limbs 21. The diameter of the through-holes 12 is greater than the outer diameter of the portion 24 of the limbs 21 accommodated in the trough-holes 11. As the trough-holes 11 and the limbs 21 are provided in a circular shape, and due to the different diameters, surrounds a gap 13 the portion 24 of the elongated limbs 21 radially.

FIG. 8 shows the configuration of the gap 13 in a more detailed top view. It can be noticed that a portion of each hollow limb 21 is placed in one corresponding through-hole provided in the first core member 10. A gap 13 surrounds each portion radial symmetrically.

When the first core member 10 and the hollow limbs 21 are made of a material with a comparable coefficient of expansion and contraction, the first core member 10 expands/contracts by nearly by the same amount as the hollow limbs 21 comprised in the through-holes. This leads to a gap 13 with minimal mechanical variation over temperature and thus to an almost constant reluctance of the magnetic circuit.

FIG. 9 illustrates an assembly of a magnetic component 2 in a sectional view. The magnetic component comprises the carrier 30 as shown in FIG. 6 and the magnetic circuit as illustrated in FIG. 7.

For assembling the first core member 10 is in a first step placed on the upper surface of the carrier 30 such that the most elongated protrution 31 and the second protrusion 32 extends via the trough-holes provided in the first core member 10.

In a subsequent step are the most elongated protrusions 31 pushed through the clearance holes 23 provided in the second core member 20 such that the distal ends 36 of the most elongated protrusions 31 projects out of the clearance hole 23 comprised in the elongated plate 22 of the second core member 20. The most elongated protrusions and the second protrusions 31, 32 secure the second core member 32. The first core member is secured by the second protrusion 31.

It can be noticed that the gap 31 between the inner side wall of the trough-hole and the portion of the elongated limbs 21 extending into the trough hole are filled by the second protrusions 32 and thereby mechanically fixated. The protrusions 31, 32 and/or the dimensions of the trough-hole and the clearance hole are configured to provide a snug fit for firmly holding the assembly.

A side wall provided by the third protrusion 33 may surround the magnetic circuit and provide an inner volume that can be filled with a potting compound in a subsequent manufacturing step.

The assembly as illustrated in FIG. 9 avoids the usage of adhesives to secure the elements of the magnetic circuit because the carrier 30 provides a stable fixation means by its mechanical construction. The magnetic properties, in particular, the reactance of the magnetic circuit is very stable over a high temperature range due to the radial gap 13 which is provided and secured by the second protrusions 32 extending via the trough-holes in the first core member 10.

The position of the first and/or second core member 10, 20 accommodated by the carrier 30 can be secured alternatively or in addition to the snug fit discussed before.

The magnetic component 2 illustrated in FIG. 10 is obtainable by a further manufacturing step. In this subsequent manufacuting step are the distal ends 36 of the most elongated protrutions 31, projecting out of the clearance holes melted to provide first and second firm mechanical connection 37, 38 for securing the core members 10, 20.

For that purporse the carrier 30 is provided by a different plastic material that can be melted, such as a thermoplastic material. When the carrier is made of a thermosetting polymer, might some parts of the carrier 30 be designed specifically to be melted. In this case might the carried 30 be made of a mixture of plastic materials comprising different material properties.

Melting the material provides the advantage over bonding with adhesives that the material is hardened immediately, which provides a much faster and more practical fixation technology.

Any other fixation technology, for instance, screwing, can be used instead of or in addition to melting.

Reference signs

| | |
|---|---|
| 1 | Magnetic circuit, magnetic circuit assembly |
| 2 | Magnetic component |
| 3 | Spacer plate |
| 4 | Housing |
| 10 | First core member |
| 11 | Through-hole |
| 12 | Elongated plate of the first core member |
| 13 | Gap |
| 14 | Opening, blind hole |
| 15 | Sidewall |
| 16 | Electrically non-conductive element, spacer |
| 20 | Second core member |
| 21 | Limb, elongated limb |
| 22 | Elongated plate of the second core member |
| 23 | Clearance hole |
| 24 | Portion of the second core member |
| 30 | Carrier |
| 31 | First protrusion, most elongated protrusion |
| 32 | Second protrusion |
| 33 | Third protrusion, sidewall of housing |
| 34 | Lace |
| 35 | Lower surface |
| 36 | Distal end, excess length |
| 37 | First firm mechanical connection |
| 38 | Second firm mechanical connection, rivet |

1. A magnetic circuit for guiding a magnetic flux generated by a coil carrying an electric current, comprising:
a magnetic core with a first core member and a second core member, wherein the first core member is configured with an opening having a sidewall with a first surface, wherein the opening accommodates only a portion of the second core member, the portion having an outer wall with a second surface, wherein the sidewall and the outer wall are mutually facing each other and the portion of the second core member is configured such that the first and second surface are separated by a gap increasing the reluctance of the magnetic circuit.

2. Magnetic circuit of claim 1, the gap encircling the portion of the second core member and being configured to extend radially or with radial symmetry relative to the portion of the second core member.

3. Magnetic circuit of claim 1, the opening of the first core member being a through-hole and the portion of the second core member extending via the full extension of the through-hole for providing the gap.

4. Magnetic circuit of claims 1, an outline contour of the portion of the second core member accommodated in the opening or through-hole being equal to an inner contour of the opening or through-hole, wherein the outline or inner contour is circular, elliptic, rectangular, polygonal or triangular.

5. Magnetic circuit of claim 1, an electrically non-conductive element being arranged in the gap in contact with the first and second surface to define and secure a distance between the first surface and the second surface.

6. Magnetic circuit of claims 1, the first and second core member comprising an elongated plate, wherein the second core member includes a plurality of elongated limbs attached to and extending from one surface of the elongated plate of the second core member; and wherein the first core member comprises a plurality of openings and/or a plurality of through-holes, each accommodating a portion of an elongated limb of the second core member.

7. Magnetic circuit of claim 6, the second core member having a clearance hole extending through at least one elongated limb and the elongated plate of the second core member.

8. Magnetic component, such as inductor or transformer, comprising:
a magnetic circuit of claims 1;
a carrier for accommodation the closed magnetic circuit with a base plate having an upper surface and a lower surface, wherein the lower surface being substantially flat and wherein the upper surface being configured with a plurality of protrusions extending from the upper surface and being configured for holding the closed magnetic circuit, wherein a first protrusion is elongated with reference to a second protrusion.

9. Magnetic component of claim 8, the first protrusion and/or the second protrusion being configured to extend via the through-hole comprised in the first core member, wherein the electrically non-conductive element of the closed magnetic circuit arranged in the gap being provided by the first or second protrusion, extending via the through-hole; and wherein the first or the second protrusion being configured to secure the first core member by providing a mechanical connection between a surface of the first core member and the protrusion.

10. Magnetic component of claim 9, the first protrusion being configured to secure the second core member, wherein the first protrusion encloses the portion of the second core member and/or extends through the clearance hole comprised in one limb of the second core member; and wherein the first or the second protrusion extends into or extends via the gap provided between the first core member accommodating a portion of the second core member in the through-hole of the first core member for holding the gap mechanically constant.

11. Magnetic component of claim 10, the first protrusion being elongated having a distal end and configured to enter the clearance hole comprised in the second core member at one end and exits the clearance hole at a second end, such that the distal end protrudes from the second end of the clearance hole.

12. Magnetic component of claims 8, with a plurality of protrusions similarly configurated as the first and/or the second protrusion each being provided for securing a first and/or a second core member; and wherein a third protrusion extending from the second surface and being configurated to circumferentially surround the base plate for providing a raised border and thereby enclosing an inner volume.

13. Method for manufacturing a magnetic component of claims 8 comprising the steps of:
providing a carrier, a first and a second core member;
securing a position of a portion of the second core member accommodated in an opening of the first core member by means of a protrusion provided on a surface of the carrier.

14. Method of claim 13, pushing a second protrusion through a through-hole provided in the first core member and providing a first firm mechanical connection between the second protrusion and the first core member by applying mechanical or thermal energy to the second protrusion.

15. Method of claim 13, pushing a first protrusion being configured in an elongated shape and having a distal end through a clearance hole provided in the second core member and providing a second firm mechanical connection between the distal end and the second core member by screwing, riveting, pressing and/or melting.
